(19) United States
(12) Patent Application Publication
(10) Pub. No.: US 2005/0115773 A1
(43) Pub. Date: Jun. 2, 2005

(54) Lift for substrate

(75) Inventors: Jae-Nam Cho, Choenan-si (KR); Geun-Soo An, Cheonan-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 10/973,651

(22) Filed: Oct. 26, 2004

(30) Foreign Application Priority Data
Oct. 27, 2003 (KR) 10-2003-0075110

(51) Int. Cl. B66B 11/04

(52) U.S. Cl. 187/251

(57) ABSTRACT

A lift for substrates is provided, which includes: a plurality of pallets for mounting the substrates and having first and second edges; a first pair of cables connected to the first edges of the pallets; a second pair of cables connected to the second edges of the pallets; and a drive unit moving the first and the second pair of cables to move the pallets upward and downward.

### BACKGROUND OF THE INVENTION

(a) Field of the Invention

The present invention relates to a lift for a substrate.

(b) Description of the Related Art

Generally, a semiconductor substrate used for a semiconductor device or a glass substrate for a flat panel display such as a liquid crystal display (LCD) and an organic light emitting display (OLED) is transferred by a conveyor system during the fabrication of the semiconductor device or the display panel. The conveyor system includes a conveyor mounting the substrate, a driving roller moving the conveyor, and a driving motor for driving the driving roller.

An LCD generally includes two panels made of glass substrates and a liquid crystal layer, while an OLED includes a signal panel made of glass substrates. The LCD displays images by applying voltages to field-generating electrodes disposed on the panels to generate electric fields, which determine the orientations of liquid crystal molecules in the liquid crystal layer. The OLED displays images by applying currents or voltages to light emitting diodes that emits light depending on the currents or voltages.

A conventional substrate transfer system for LCDs transfers glass substrates to several process equipments. In particular, the substrates are transferred up and down with being contained in cassettes that in turn are contained in a cage of a lift.

Since such a batch lifting system may not be suitable for large glass substrates and an in-line system, a single-substrate lifting system that lifts one glass substrate in a lifting cycle of a lift is suggested. However, the single-substrate lifting system increases the tact time taken by the lift.

### SUMMARY OF THE INVENTION

A lift for substrates is provided, which includes: a plurality of pallets for mounting the substrates and having first and second edges; a first pair of cables connected to the first edges of the pallets; a second pair of cables connected to the second edges of the pallets; and a drive unit moving the first and the second pair of cables to move the pallets upward and downward.

The pallets may be flexible and each of the pallets may include a plurality rolls tied in parallel.

The drive unit may include a drive motor and a plurality of pulleys coupled to the drive motor.

The pulleys may include a drive pulley directly coupled to the drive motor to be driven by the drive motor and a plurality of idle pulleys coupled to the first and the second pairs of cables.

The idle pulleys may include a first pulley arranged substantially horizontal to the drive pulley, second and third pulleys arranged substantially vertical to the drive pulley, and fourth and fifth pulleys arranged substantially vertical to the first pulley and substantially horizontal to the second and the third pulleys.

Each of (a) a first pulley, (b) one of the second and the third pulleys, and (c) one of the fourth and the fifth pulleys may include a pair of separated bodies disposed in a straight line.

At least one of the pulleys may include a single body.

The pallets may be curved with contacting circumferences of the at least one of the pulleys.

The pallets may move upward with being horizontally aligned and it may move downward with being vertically aligned.

Alternatively, the pallets may move downward with being horizontally aligned and it may move upward with being vertically aligned.

The lift may further include a frame containing the pallets, a fan filter provided at walls of the frame, or an exhaust disposed at a bottom of the frame.

The lift may further include a pair of conveyors for feeding the substrates to the pallets and for taking off the substrates from the pallets.

### BRIEF DESCRIPTION OF THE DRAWINGS

The present invention will become more apparent by describing embodiments thereof in detail with reference to the accompanying drawings in which:

FIG. 1 is a lifting system for substrates according to an embodiment of the present invention; and

FIGS. 2 and 3 are schematic perspective view illustrating the movement of pallets in the lifting system shown in FIG. 1.

### DETAILED DESCRITPION OF THE PREFERRED EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

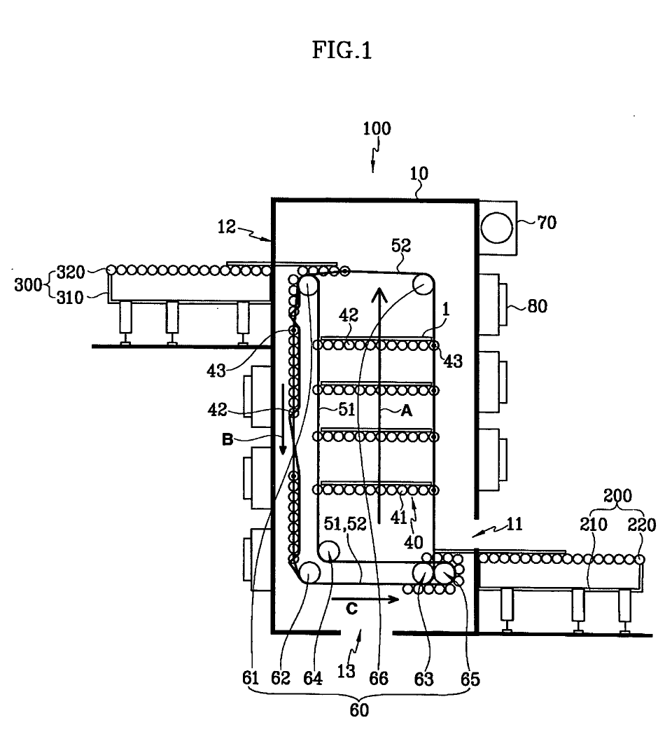

Now, a lifting system according to an embodiment of the present invention will be described in detail with reference to FIGS. 1-3.

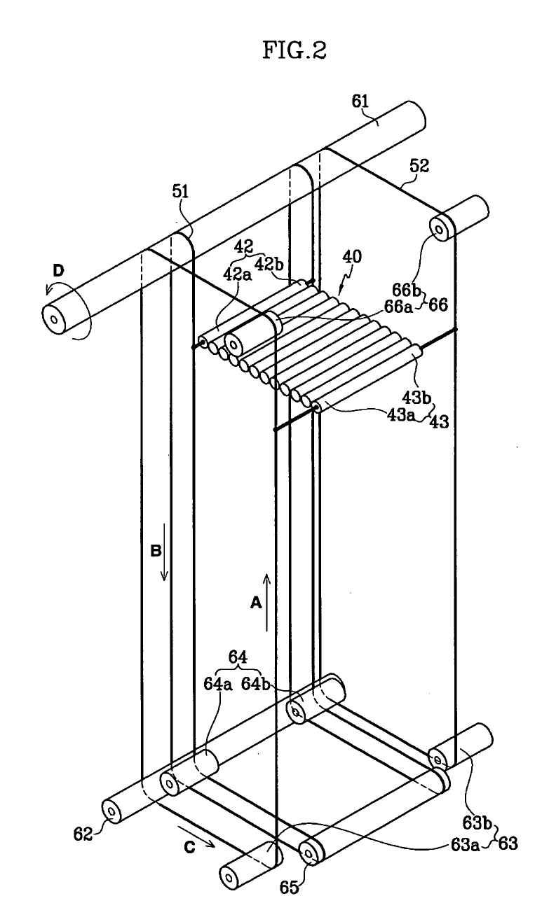

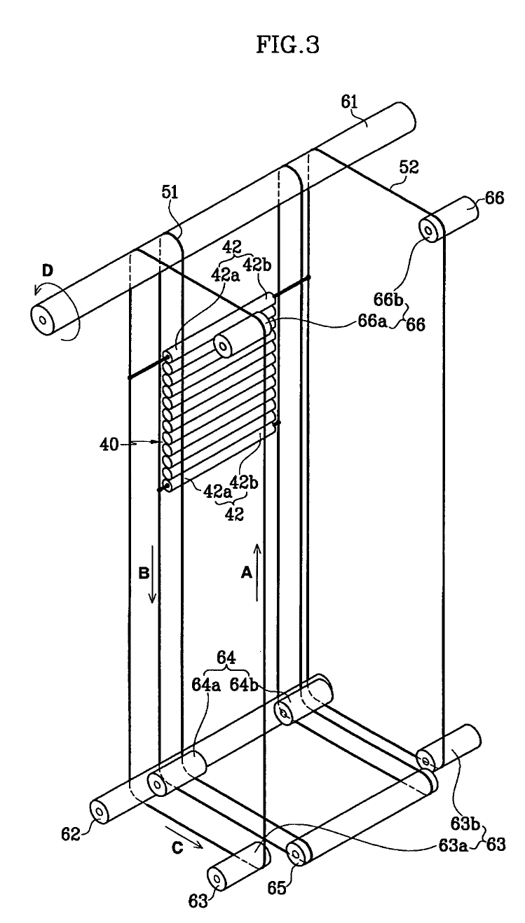

FIG. 1 is a lifting system for substrates according to an embodiment of the present invention and FIGS. 2 and 3 are schematic perspective view illustrating the movement of pallets in the lifting system shown in FIG. 1.

Referring to FIG. 1, a lifting system according to this embodiment includes a lift 100 for elevating/lowering substrates 1 and a pair of lower and upper conveyors 200 and 300 for feeding on/taking off the substrates 1.

As shown in FIGS. 1-3, the lift 100 includes a cuboidal frame 10, a plurality of flexible pallets 40 disposed in the frame 10, first and second pairs of cables 51 and 52 coupled to the pallets 40, and a drive unit 60 and 70 for driving the first and the second cables 51 and 52.

The frame 10 has a pair of lower and upper entrances/exits 11 and 12 disposed near its bottom and top, respectively, for receiving and discharging substrates 1. A plurality of fan filter units (FFU) 80 for introducing clean air into the interior of the frame 10 are disposed at a sidewall of the frame 10, and an exhaust 13 for discharging the air in the frame 10 is disposed at a bottom of the frame 10.

The drive unit 60 and 70 includes a drive motor 70 and a plurality of pulleys 60 coupled to the drive motor 70. The motor 70 is disposed out of the frame 10 for preventing the contamination of substrates 1.

The pulleys 60 include a drive pulley 61 directly coupled to the drive motor 70 preferably through chains or belts (not shown) to be driven by the drive motor 70 and a plurality of idle pulleys 62-66 coupled to the cables 51 and 52. The pulleys 60 are placed at the transitions of moving direction of the cables 51 and 52 or the pallets 40. The drive pulley 61 is disposed at an upper left side of the frame 10 and the idle pulleys 62-66 include an upper right pulley 66, first and second lower left pulleys 64 and 62, and first and second lower right pulleys 65 and 63. Each of the upper right pulley 66, the second lower left pulley 62, and the first lower right pulley 65 include a single body, while each of the upper right pulley 66, the first lower left pulley 64, and the second lower right pulley 63 includes a pair of bodies 66a and 66b, 64a and 64b, or 63a and 63b disposed in a straight line and separated from each other with a distance larger than the width of the pallet 40.

The cables 51 and 52 contact the drive pulley 61 to move in accordance with the rotation of the drive pulley 61. The first pair of cables 51 contact the idle pulleys 62, 64 and 65 and the second pair of cables 52 contact the idle pulleys 62, 63 and 66. When viewed from the axis of the pulleys 61-66 as shown in FIG. 1, the first pair of cables 51 approximately form a double-lined character “L,” while the second pair of cables 52 form a rectangle. In detail, the cables 51 and 52 approximately coincide with each other in a vertical direction between the drive pulley 61 and the idle pulley 62 and in a horizontal direction between the second lower left idle pulley 62 and the lower right idle pulleys 63 and 65. The first and the second pairs of cables 51 and 52 then get away from each other. In detail, the first pair of cables 51 turn back around the first lower right pulley 65 to reach the first lower left pulley 64 and turn around the first lower left pulley 64 to run upward to the drive pulley 61, while the second pair of cables 52 turn around the second lower right pulley 65 to go upward to the upper right pulley 66 and turn around the upper right pulley 66 to run to the drive pulley 61.

Each pallet 40 includes a plurality of rolls 41 that are tied in parallel to be flexible. In addition, each pallet 40 has two opposite edges 42 and 43 extending perpendicular to its moving direction and coupled to the first pair of cables 51 and the second pair of cables 52, respectively. The two opposite edges 42 and 43 include respective rolls and each of the edge rolls 42 and 43 has two end portions 42a and 42b or 43a and 43b coupled to respective cables 51 or 52 via connections.

The distance between the first pair of cables 51 and between the second pair of cables 52 is larger than the length of the edge rolls 42 and 43, and the distance between the second pair of cables 52 is larger than the distance between the first pair of cables 51. In addition, the distance between the first pair of cables 51 and the second pair of cables 52 The lower feed-on/take-off conveyor 200 is disposed near the lower entrance/exit 11 of the frame 10 and includes a support 210 and a plurality of rolls 220. Likewise, the upper feed-on/take-off conveyor 300 is disposed near the upper entrance/exit 12 of the frame 10 and includes a support 310 and a plurality of rolls 320.

The lift 100 can elevate or lower the substrates 1 by adjusting the rotating direction of the drive pulley 61. For example, the pallets 40 elevate the substrates 1 upward when the drive pulley 61 rotates counterclockwise denoted by a reference character D in FIG. 2. On the contrary, the pallets 40 lower the substrates 1 downward when the drive pulley 61 rotates clockwise.

During the elevation of the lift 100, the drive unit 60 and 70 moves the pallets 40 at the bottom of the lift 100 in a horizontal direction away from the lower conveyor 200 by aligning the pallets 40 to be substantially horizontal and making one edge 42 of each pallet 40 in advance of the other edge 43. The lower conveyor 200 carries the substrates 1 on its surface and loads the substrates 1 on the horizontally-moving pallets 40 through the lower entrance/exit 11 and the feed-on process of the lower conveyor 200 is performed in a sequential manner. After loading the substrates 1, the drive unit 60 and 70 moves the pallets 40 mounting the substrates 1 in an upward direction A from the bottom to the top by maintaining the pallets 40 to be horizontal and simultaneously moving the edges 42 and 43 of each pallet 40. After reaching the top, the drive unit 60 and 70 moves the pallets 40 in a horizontal direction toward the upper conveyor 300 to take off the substrates 1 to the upper conveyor 300 through the upper exit/entrance 12 by maintaining the pallets 40 to be horizontal, making the edges 42 of the pallets 40 turn down around the drive pulley 61, and making the edges 43 of the pallets 40 follow the fore edges 42. The upper conveyor 300 loads the substrates 1 on its surface and takes away the substrates 1 from the lift 100.

After taking off the substrates 1, the drive unit 60 and 70 moves the pallets 40 downward in a vertical direction B from the top to the bottom by making the pallets 40 to be vertical and making the edges 42 of the pallets 40 in advance of the edges 43 of the pallets 40. The drive unit 60 and 70 make the pallets 40 turn around the second lower left pulley 62 at the bottom to move in a horizontal direction C toward the lower conveyor 200 by aligning the pallets 40 to be substantially horizontal and making the edges 42 of the pallet 40 in advance of the other edges 43.

The flexible pallets 40 can be curved at the transitions of their moving directions with contacting the circumferences of the pulleys 61-66. Referring to FIG. 1, the pallets 40 are curved along the circumferences of the drive pulleys 60 when they turn their moving directions from the upward direction A to the downward direction B, from the downward direction B to the horizontal direction C at a bottom of the frame 10, and from the horizontal direction C to the upward direction A.

The lowering operations of the conveyors 200 and 300, the pulleys 61-66, and the pallets 40 are performed in a reversed manner to the elevating operations thereof.

In the above-described lift 100, since several pallets 40, which are aligned parallel to a ground to mount the substrates 1, are disposed in a height of the frame 10, the tact time for elevating/lowering the substrates 1 is short. In addition, since the number of the parallel-aligned pallets 40 can be determined regardless of the height of the frame 10, the tact time for elevating/lowering the substrates 1 may be hardly affected by the height of the frame 10.

In addition, the sequential elevation/lowering of the substrates 1 can be adapted to an in-line system.

While the present invention has been described in detail with reference to the preferred embodiments, those skilled in the art will appreciate that various modifications and substitutions can be made thereto without departing from the spirit and scope of the present invention as set forth in the appended claims.

1. A lift for substrates, the lift comprising:
a plurality of pallets for mounting the substrates and having first and second edges;
a first pair of cables connected to the first edges of the pallets;
a second pair of cables connected to the second edges of the pallets; and
a drive unit moving the first and the second pair of cables to move the pallets upward and downward.

2. The lift of claim 1, wherein the pallets are flexible.

3. The lift of claim 2, wherein each of the pallets includes a plurality rolls tied in parallel.

4. The lift of claim 1, wherein the drive unit comprises a drive motor and a plurality of pulleys coupled to the drive motor.

5. The lift of claim 4, wherein the pulleys comprise a drive pulley directly coupled to the drive motor to be driven by the drive motor and a plurality of idle pulleys coupled to the first and the second pairs of cables.

6. The lift of claim 5, wherein the idle pulleys includes a first pulley arranged substantially horizontal to the drive pulley, second and third pulleys arranged substantially vertical to the drive pulley, and fourth and fifth pulleys arranged substantially vertical to the first pulley and substantially horizontal to the second and the third pulleys.

7. The lift of claim 6, wherein each of (a) a first pulley, (b) one of the second and the third pulleys, and (c) one of the fourth and the fifth pulleys comprises a pair of separated bodies disposed in a straight line.

8. The lift of claim 7, wherein at least one of the pulleys comprises a single body.

9. The lift of claim 8, wherein the drive pulley comprises a single body.

10. The lift of claim 8, wherein at least one of the idle pulleys comprises a single body.

11. The lift of claim 8, wherein the pallets are curved with contacting circumferences of the at least one of the pulleys.

12. The lift of claim 11, wherein the pallets move upward with being horizontally aligned and move downward with being vertically aligned.

13. The lift of claim 11, wherein the pallets move downward with being horizontally aligned and move upward with being vertically aligned.

14. The lift of claim 1, further comprising a frame containing the pallets.

15. The lift of claim 14, further comprising a fan filter provided at walls of the frame.

16. The lift of claim 14, further comprising an exhaust disposed at a bottom of the frame.

17. The lift of claim 1, further comprising a pair of conveyors for feeding the substrates to the pallets and for taking off the substrates from the pallets.
